(19) United States
(12) Patent Application Publication
(10) Pub. No.: US 2008/0243661 A1
(43) Pub. Date: Oct. 2, 2008

(54) SYSTEM AND METHOD OF ACQUIRING INSTANT CREDIT

(76) Inventors: Ryan Joseph BUSSONE, Farmington Hills, MI (US); Fred John Seidelman, Northville, MI (US); Lisa Scappaticci Krueger, Northville, MI (US)

Correspondence Address: THELEN REID BROWN RAYSMAN & STEINER LLP, PO BOX 640640, SAN JOSE, CA, 95164-0640, US

(21) Appl. No.: 11/694,230

(22) Filed: Mar. 30, 2007

(51) Int. Cl. G06Q 40/00

(52) U.S. Cl. 705/35

(57) ABSTRACT

A computer-implemented system and method of providing for a credit card offer to a customer during a transaction for the customer to acquire an asset offered by a dealer is provided. The computer-implemented method may include acquiring, via a computer operated by the dealer, information for inclusion in a first credit application for financing the asset acquisition. Based on at least a portion of the acquired information, a second credit application is generated for submission to a credit card institution, where the second credit application is electronically sent to a credit card institution. A status indication associated with the approval of the second credit application based on an electronic communication received from the credit card institution is displayed on the computer operated by the dealer.

### COPYRIGHT AND LEGAL NOTICES

A portion of the disclosure of this patent document contains material which may be subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### FIELD OF THE INVENTION

The present invention relates generally to a system and method for electronically providing a line of credit to a customer, and more particularly, to electronically providing the customer with an opportunity, upon pre-approval, to instantly receive and utilize such a line of credit based on another loan transaction.

### BACKGROUND

The exchange of electronic information and messaging in retail applications, especially the world of vehicle sales, has become common place with the expansion and advancement of the Internet and telecommunications. For example, dealership employees (e.g., finance and insurance staff) have the capability of electronically initiating one or more financial loan transactions on behalf of customers, thereby enhancing both the efficiency and accuracy associated with securing such loans. With this in mind, it may be advantageous to instantly provide customers with an opportunity to receive additional electronically provided credit services (e.g., credit cards) based on other loan transaction, thereby increasing both potential retail sales and customer buying potential.

### SUMMARY OF THE INVENTION

According to an embodiment of the invention, a computer-implemented method of providing a credit card offer to a customer during a transaction for the customer to acquire an asset offered by a dealer is provided. The computer implemented method may include acquiring, via a computer operated by the dealer, information for inclusion in a first credit application for financing the asset acquisition. Based on at least a portion of the acquired information, a second credit application is generated for submission to a credit card institution, where the second credit application is electronically sent to a credit card institution. A status indication associated with the approval of the second credit application is displaying on the computer operated by the dealer based on an electronic communication received from the credit card institution.

According to another embodiment of the invention, a method of receiving a credit line at a vehicle dealership is provided. The method includes submitting at the vehicle dealership a first credit application to a financial source for receiving a first credit approval associated with an acquisition and extracting information fields from the first credit application. A second credit application to a credit card institution is generated for receiving a second credit approval based on the extracted information fields, where the second credit application is generated based on an existing business arrangement between the vehicle dealership and the financial source. The second credit application is sent to a credit card institution for pre-approval of the second credit application. At the vehicle dealership, a status indication associated with the pre-approval of the second credit card application is then received.

According to yet another embodiment of the invention, a method of receiving a credit line at a vehicle dealership is provided. The method includes submitting, at the vehicle dealership, a first credit application to a financial source for receiving a first credit approval associated with an acquisition. Information fields are then extracted from the credit application. A second credit application is submitted to a credit card institution for receiving a second credit approval based on the extracted information fields, where at least one term associated with the second credit approval is customized according to at least one business term between the financial source and the credit card institution. The second credit, application is then sent to a credit card institution for pre-approval of the second credit application, while, at the dealership, a status indication associated with the pre-approval of the second credit card application is received.

According to yet another embodiment of the invention, a method of receiving a credit line at a vehicle dealership utilizing a credit aggregation management system is provided. This method includes submitting, using the credit aggregation management system, a first credit application to a financial source for receiving a first credit approval associated with an acquisition. Information fields are then extracted from the credit application. A second credit application is submitted to a credit card institution for receiving a second credit approval based on the extracted information field, whereby the credit card institution generates a credit card version of the financial source. The second credit application is then sent to a credit card institution for pre-approval of the second credit application, where upon approval of the second credit application, the vehicle dealership receives a fee from the credit card institution. A status indication associated with the pre-approval of the second credit card application is then received at the vehicle dealership.

According to another embodiment of the invention, a system for providing instant credit to a customer of a vehicle dealership via a communications network is provided. The system may include a database for mapping the vehicle dealership to at least one financial source based on the customer seeking from the financial source a first credit pre-approval for an acquisition, and a credit aggregation management system operatively coupled to the database, whereby the credit aggregation management system provides access to the financial source on behalf of the customer seeking the first credit pre-approval. The credit aggregation management system may facilitate acquisition of the first credit pre-approval from the financial source by receiving credit card application information. A credit acquisition application program operatively coupled to the credit management system and the database facilitates acquisition of a second credit pre-approval from a credit card institution over the communication network on behalf of the customer based on at least a portion of the received credit card information. Acquisition of the second credit pre-approval is contingent upon an established business relationship between the vehicle dealership and the financial source.

According to another embodiment of the invention, a computer program product is provided, whereby the computer program product includes a computer program embodied on at least one computer readable medium, such that the computer program when executed is operative in performing a method for providing a credit card offer to a customer during a transaction for the customer to acquire an asset offered by a dealer in a computer environment. The method includes receiving information for inclusion in a first credit application for financing the asset acquisition and generating, based on at least portion of the acquired information, a second credit application for submission to a credit card institution. Sending the second credit application to a credit card institution electronically and providing a status indication associated with the approval of the second credit application based on an electronic-communication received from the credit card institution.

It will be appreciated by those skilled in the art that the foregoing brief description and the following detailed description are exemplary and explanatory of this invention, but are not intended to be restrictive thereof or limiting of the advantages which can be achieved by this invention. Additionally, it is understood that the foregoing summary of the invention is representative of some embodiments of the invention, and is neither representative nor inclusive of all subject matter and embodiments within the scope of the present invention. Thus, the accompanying drawings, referred to herein, and constituting a part hereof, illustrate embodiments of this invention, and, together with the detailed description, serve to explain principles of this invention.

### BRIEF DESCRIPTION OF DRAWINGS

Various embodiments of the invention are illustrated in the figures of the accompanying drawings, which are meant to be exemplary and not limiting, and in which like references are intended to refer to like or corresponding parts.

FIG. 1 illustrates a system for providing a credit card to customers of vehicle dealerships over a communication network according to an embodiment of the invention;

FIGS. 2A-2D are operational flow diagrams for acquiring the credit card on behalf of customers of vehicle dealerships according to an embodiment of the invention; and

FIGS. 3A-3H are generated webpage screen shots, provided to an internet browser at the vehicle dealerships, for acquisition of the credit card for customers according to an embodiment of the invention.

### DETAILED DESCRIPTION

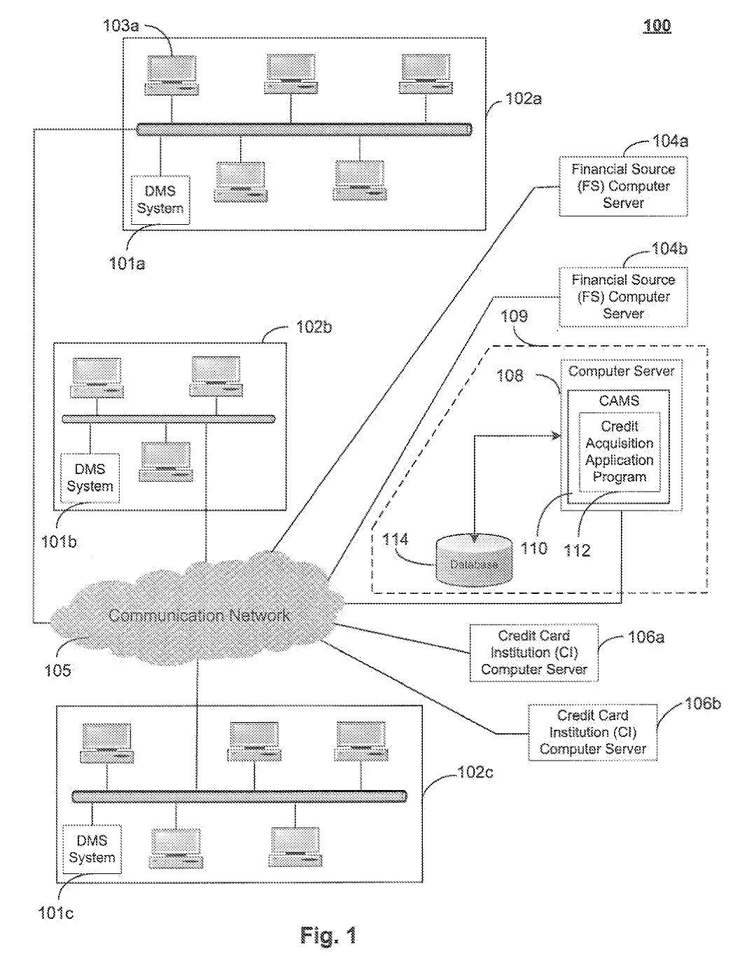

As will be understood, for purposes of clarity of exposition, the illustrative embodiments described hereinbelow in connection with FIGS. 1, 2A-2D, and 3A-3H relate to providing a credit card offer to a customer applying for automobile financing, such as for buying or leasing an automobile offered for sale or lease by an automobile dealership. Embodiments of the present invention, however, are not limited to such automobile retail environments and automobile vehicle financing applications, but may be implemented in myriad other commercial transaction environments and asset financing transactions, including both unsecured and secured credit applications and financing.

For instance, such applications and financing include (i.e., but are not limited to) student loans, personal property sales and financing (including Uniform Commercial Code filings), real estate sales and home equity loans involving mortgage processing, and loans against any asset such as stocks, bonds, retirement funds and other financial instruments or financial interests. Further, vehicle financing transactions may involve vehicles other than automobiles (e.g., including cars and trucks), such as boats and other watercraft or marine vehicles, recreational vehicles, motorcycles, off-road vehicles, and aircraft. As such, as used herein, a financing transaction may be a lease transaction, a loan transaction, or any other transaction in which a financial source provides financing for a party to obtain use of, and possibly also legal title to, an asset, which asset includes, for example, one or more items such as automobiles (e.g., cars, trucks, etc.), marine, recreational vehicles (RV), aircraft, motorcycles, off-road vehicles, consumer goods, real estate, contract rights, intangible property rights, home furnishings, home improvement, office equipment, inventory, manufacturing equipment, livestock, farm equipment, financial interests, etc. Additionally, for convenience, as used herein, the term “acquisition” used in connection with an asset (e.g., an “asset acquisition” or “acquiring an asset”) may involve a purchase (i.e., buying or a corresponding sale) or a lease of the asset, and thus a financing transaction relating to an acquisition may be a lease transaction, a loan transaction, or any other transaction in which a financial source provides financing for a party to obtain use of, and possibly also legal title to, the asset.

Additionally, while the ensuing embodiment is described in connection with a transaction involving personal communication (e.g., face-to-face, telephonic, etc.) between a customer and a dealer at a brick-and-mortar dealership, alternative embodiments of the present invention may be implemented in an e-commerce or online shopping environment (e.g., online automobile dealer), where a customer may remotely browse an online retailer's website for locating and buying or leasing inventory offered for sale or lease by the online retailer, though such e-commerce or online shopping may also involve some communication between customer and an employee or human agent of the online dealer (e.g., to obtain additional information and/or effect all or part of the transaction).

FIG. 1 illustrates a system 100 according to an embodiment of the invention, where the system comprises automobile dealership computer systems 102a, 102b, 102c, financial source (FS) computer systems 104a, 104b, credit card institution (CI) computer systems 106a, 106b, a credit management computer system (CMS) 109 including a CMS server 108 communicably coupled to a CMS database 114, and a communication network 105. Each of the FS, CI, and CMS computer systems is schematically depicted as a computer server; however, those skilled in the art understand that each of these systems may be implemented as one or more servers (e.g., a server cluster) and/or other computer systems (e.g., comprising hardware and/or firmware and/or software) implementing various software applications or modules to provide the processing, communications, and other operations for implementing the methods described hereinbelow.

In various, embodiments, dealerships 102a, 102b, and 102c are independent automobile dealerships (e.g., separately owned businesses) and, as schematically depicted, each comprise a computer network comprising one or more computer devices (e.g., 103a) communicably coupled to a Dealer Management System (DMS) 101a, 101b, 101c, which may be operating on one or more servers on the dealership's computer network. As known to those skilled in the art, a typical DMS (e.g., such as provided by ADP, Inc. or Reynolds and Reynolds, Inc.) or similar system stores and manages dealership data such as that related to inventory, sales, parts, service, customers, etc. In use, the DMS allows salespersons, management, and other authorized users to access stored dealership data. For example, a salesperson may access the DMS via a computer device (e.g., 103a) to determine whether the dealership has a certain vehicle in its existing inventory.

As will be understood by those skilled in the art, the illustrative dealership computer devices (e.g., 103a) are not limited to personal computers, terminals, or workstations, nor limited to wired network connections within the dealership, but may include any computing device that may communicably connect (e.g., wirelessly; via a WAN, via a virtual private network (VPN) connection, via the Internet, etc.; via one or more hardware devices, such as routers, switches, hubs, etc.; and using any of a variety of communication protocols; etc.) to the dealership DMS and execute one or more software modules or applications (e.g., a web browser) allowing a dealer operating the computer device to enter or otherwise acquire information concerning the potential sale or lease (e.g., vehicle and customer information) such that a credit application may be generated and appropriately transmitted to provide an automobile financing application to a financial source and a credit card application to a credit card institution, with the dealer receiving via the computer device an indication as to the status (e.g., approval) of the automobile financing and the credit card. More specifically, as will be further understood below, in various embodiments of the invention, a dealer assisting a customer in arranging for financing to complete the automobile transaction (e.g., lease or sale) may use a dealership computer (e.g., 103a) to access the DMS to acquire vehicle information (and possibly also information for a return customer), and may also access (e.g., navigating via a web browser) credit management system (CMS) 109 (e.g., which may be web based) to arrange for financing of the vehicle transaction.

As indicated above, while the embodiments described herein in connection with FIGS. 1-3 are directed to automobile dealerships and financing, in various embodiments of the present invention, a dealer is not limited to an automobile dealer, but is any individual or entity (e.g., commercial dealership, third party brokers, vendors, retailers, and manufacturers) in the business of selling or leasing assets, including merchandise, to customers, and in doing so may communicate with lenders as well as customers.

In accordance with various embodiments, financial source (FS) computer systems 104a and 104b provide processing platforms for processing credit applications for financing (e.g., loans and/or leases) an automobile being offered for sale by a dealer to a customer. More specifically, as will be further understood front the illustrative operational flow described below, in various embodiments FS computer systems 104a and 104b process credit card applications received via CMS 109 from one or more dealerships (e.g., 102a). This, processing may include, for example, communicating with one or more credit agencies (not shown) and sending a response indicative of credit approval to the dealer via the CMS 109. A financial source (also referred to herein as a lender) may be considered as any entity providing financing for asset (e.g., automobiles in the illustrative embodiment of FIG. 1) transactions, e.g., banks and credit unions, manufacturer-related financing companies, financial institutions, and other credit granting institutions.

As will be further understood from the operational description below, credit card institution (CI) servers 106a, 106b schematically represent computing systems provided by respective credit card institutions that process credit card applications received via CMS 109 from one or more dealerships (e.g., 102a). This processing may include, for example, pre-approval processing, booking of pre-approved credit offers accepted by customers, and issuing a temporary credit card, and may include communicating with one or more credit agencies (not shown). Such credit card institutions may be a corporate affiliate of a financial source; for example, CI 106a may be the credit card issuing division or branch of the financial source, or may have a common parent company with the financial source. Alternatively, or in some implementations, additionally, a credit card issuer may not be a corporate affiliate of a financial source, but may have an established contractual relationship such that the credit card institution will process credit applications for the financial source in connection with vehicle credit applications received by the financial source via CMS 109. It will also be understood that the CI may be an agent of a credit card issuer or otherwise have a business relationship with a credit card issuer, such that the CI handles credit card application processing for the credit card issuer. Thus, for example, CI 106a may process credit card applications (e.g., indicating approval) on behalf of a banking entity whose name appears on the issued credit card, and which banking entity may be affiliated with a vehicle financing financial source (e.g., FS 104b), while credit CI 106a has no corporate affiliation with the banking entity, nor with the vehicle financing financial source.

In accordance with various embodiments, CMS system 109 includes a credit aggregation management system (CAMS) 108 implemented as a web-based application, providing independent dealerships (e.g., 102a, 102b, 102c) a common platform for submitting automobile credit application information to one or more finance sources (e.g., finance sources 104a, 104b) with which they do business. CMS 109 maintains secure, separate accounts for each independent dealership participant (e.g., subscriber) of CMS 109, which dealerships may access CMS 109 via communication network 105 (e.g., via an secure (e.g., encrypted) communication link). CMS computer system 109 may be provided by a third-party service provider, though in various embodiments such a system may be provided, for example, by one or more affiliated dealers. When a dealer navigates to CMS 109, CMS 109 may present the dealer via the computer device with an online form, which may he populated with vehicle and customer information from the DMS, and in which any additional information related to the financing transaction may be entered.

CMS 109 also includes a credit acquisition application program (CAP) 112, which in some embodiments, as schematically depicted, may be implemented as a module included within the CAMS system, though as will be understood by those skilled in the art, the CAP functionality may be provided as a separate application running on the same or different server as the CAMS application. CAP 112 is operative in providing the processing and routing functions required for credit card application processing related to a vehicle financing application. For example, CAP 112 acquires (e.g., extracts) at least a portion of the information received by CMS 109 from a dealership in connection with an automobile financing application, and generates and forwards a credit card request (e.g., application) to a credit card institution that is contractually obligated to, or otherwise designated or approved by, the financial source that processes the vehicle financing application. As will be understood based on the foregoing, for each dealership, database 114 stores information identifying or otherwise relating to financial sources associated with the dealership, including information identifying the one or more credit card institutions associated with each financial source.

As indicated above, while CMS computer system 109 is depicted as a computer server 108 communicably coupled to a database 114, generally, CMS 109 may be implemented as, or be part of, a multi server environment having access to multiple databases to provide such a platform (e.g., including geographically dispersed servers to provide service to geographically dispersed dealers). Although the CAMS 110 and CAP 112 are illustrated as being hosted by the web server 108, either or both of these applications or modules may reside in other locations in the system 100. For example, in various alternative embodiments, the CAMS and/or CAP may reside locally in the dealership (e.g., on a dealership LAN server and/or locally on a dealer workstation or other desktop computer). In some embodiments, one or more of these modules, or portions thereof, may be incorporated into a dealerships local DMS (e.g., DMS 101a). Additionally, in various embodiments, the DMS system, or portions thereof, may be implemented as a web-based service, similar to the CMS system 109, and in some implementations such a web-based DMS system, or portions thereof, may be bundled or included with, or otherwise operate as pan of, the web-based CMS system 109. In short, the particular details of the system 100 may vary depending upon the particular application or embodiment of the present invention.

Communications between the various dealership, FS, CI, and CMS computing systems, as may be required according to various embodiments of the present invention, are provided via communications network 105, which may include any configuration of private and/or public networks and, in the illustrative embodiment, includes the Internet. Communications and messaging formats and protocols may be include, for example, XML based messaging, such as according to STAR (Standards for Technology in Automotive Retail).

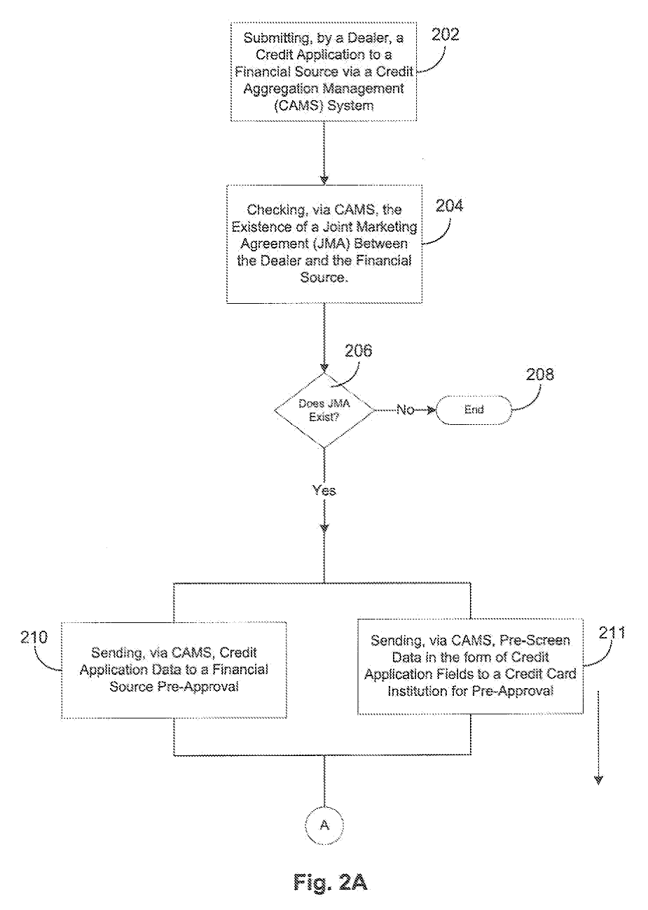

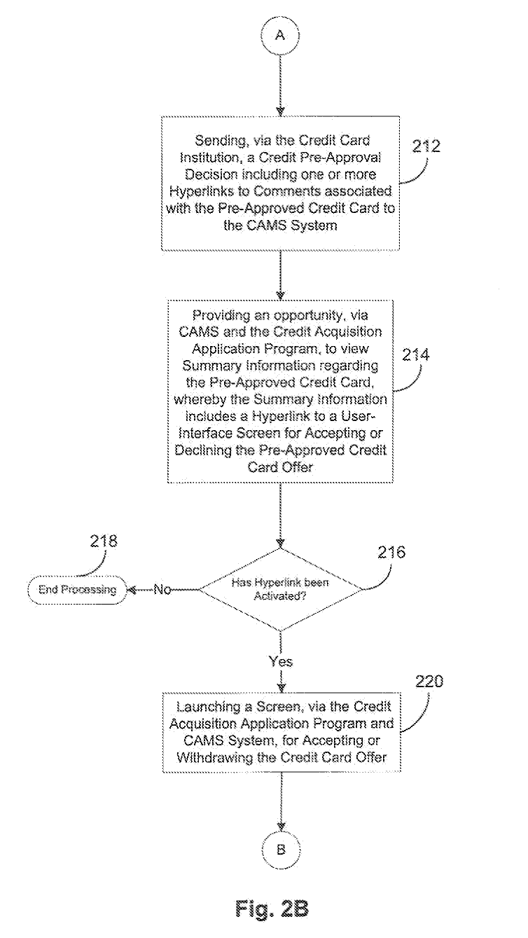

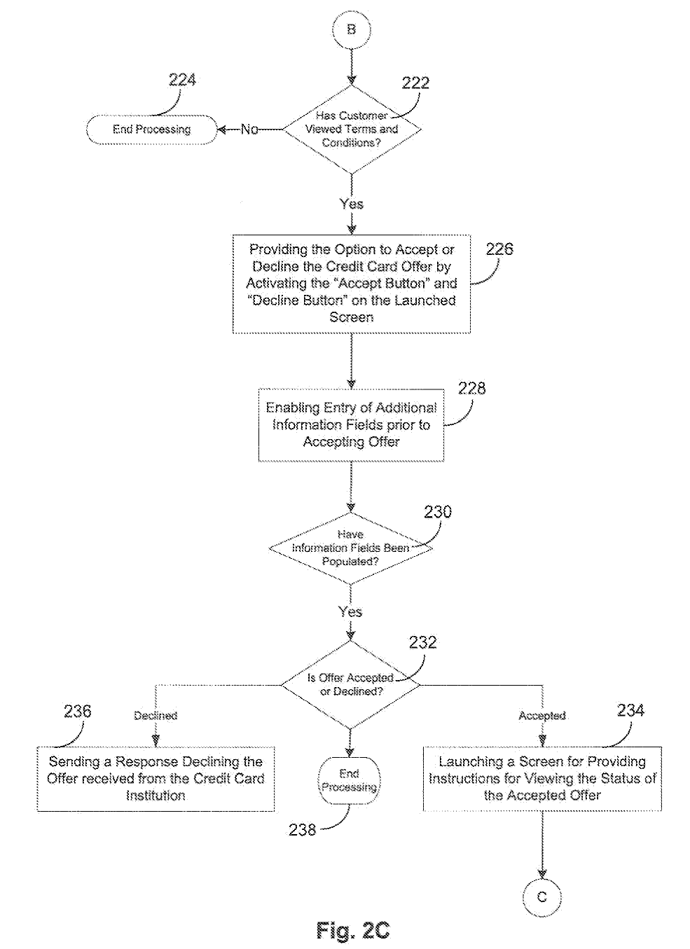

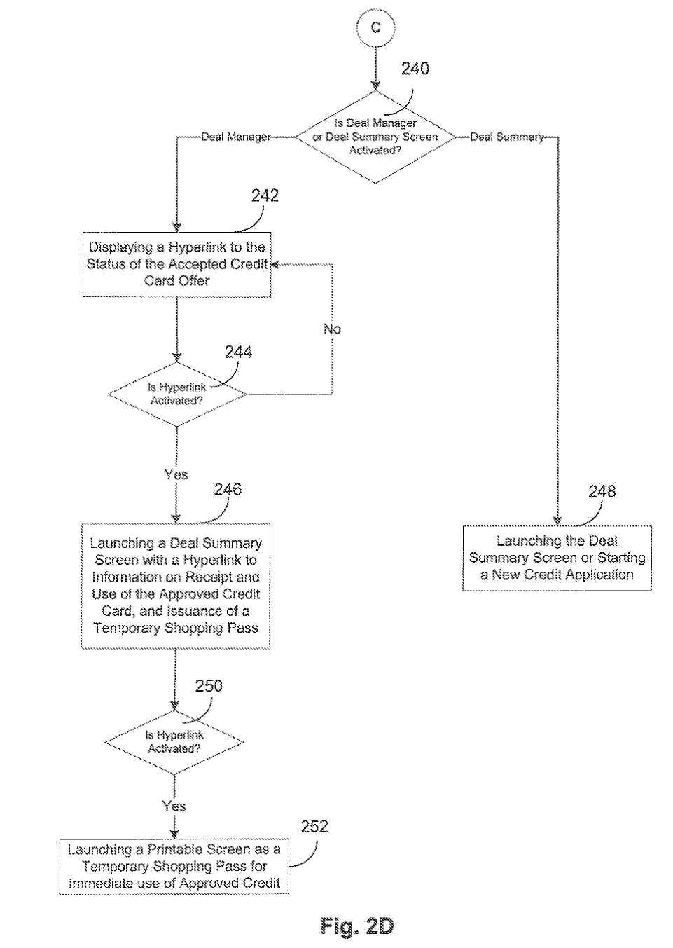

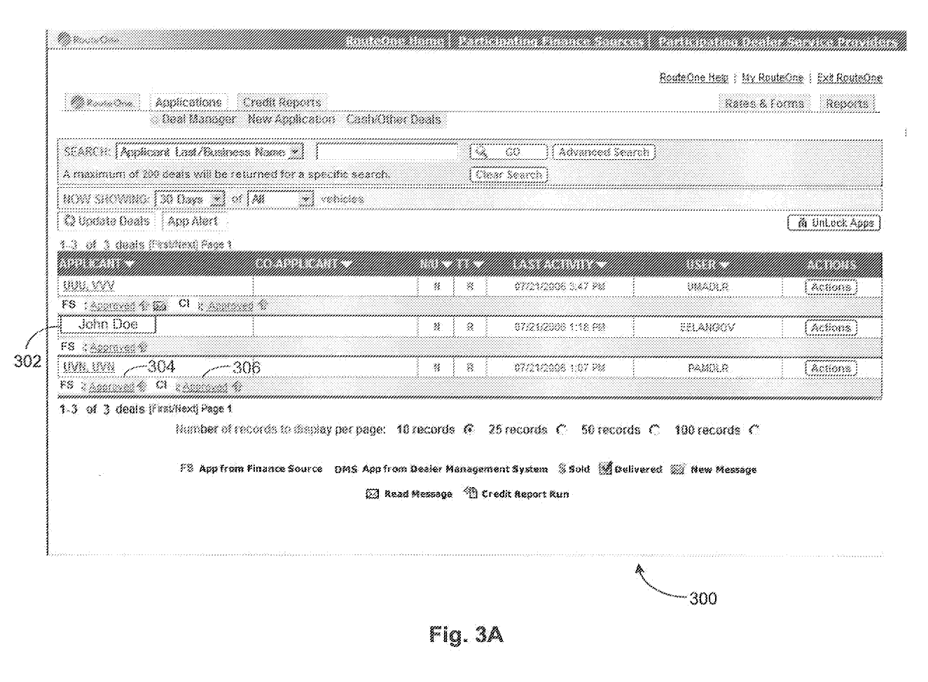

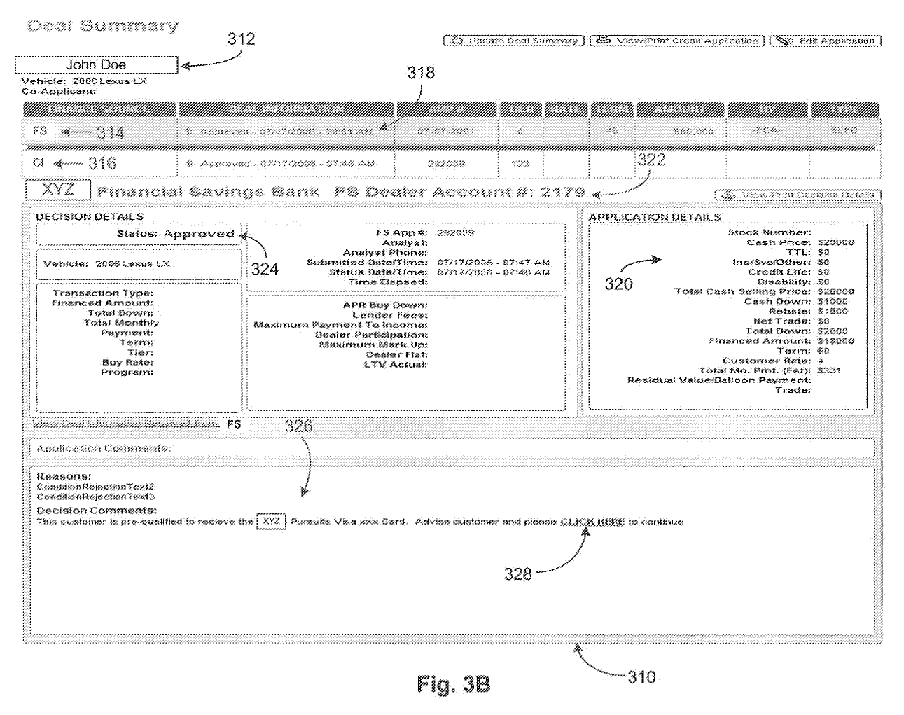

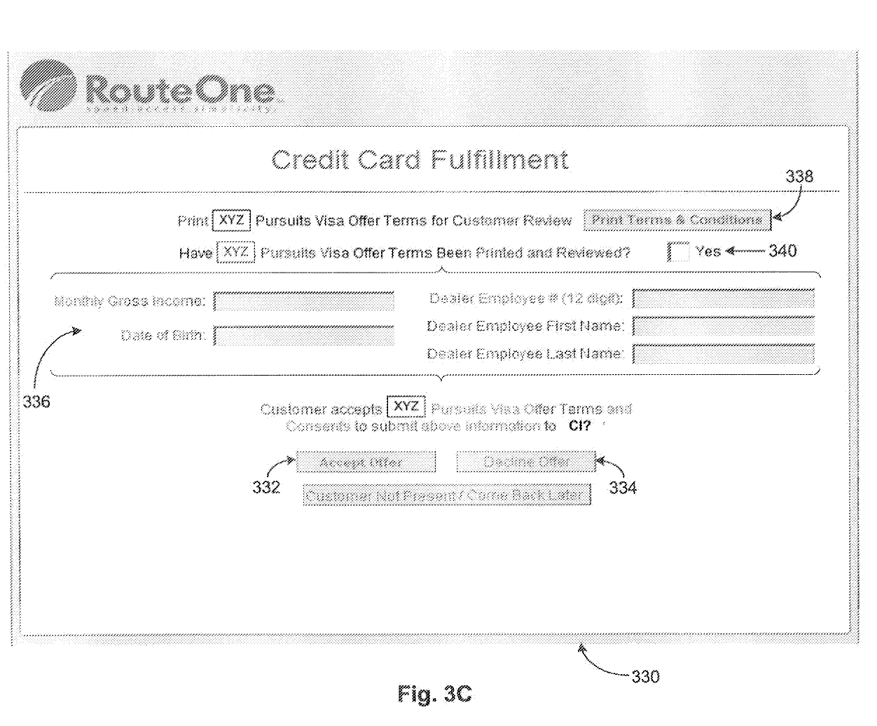

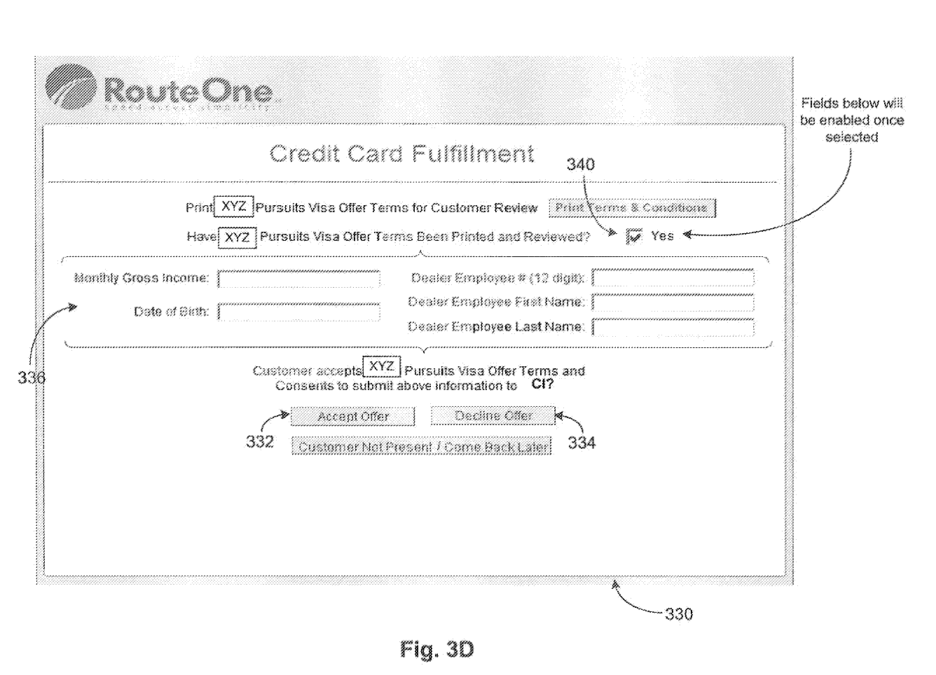

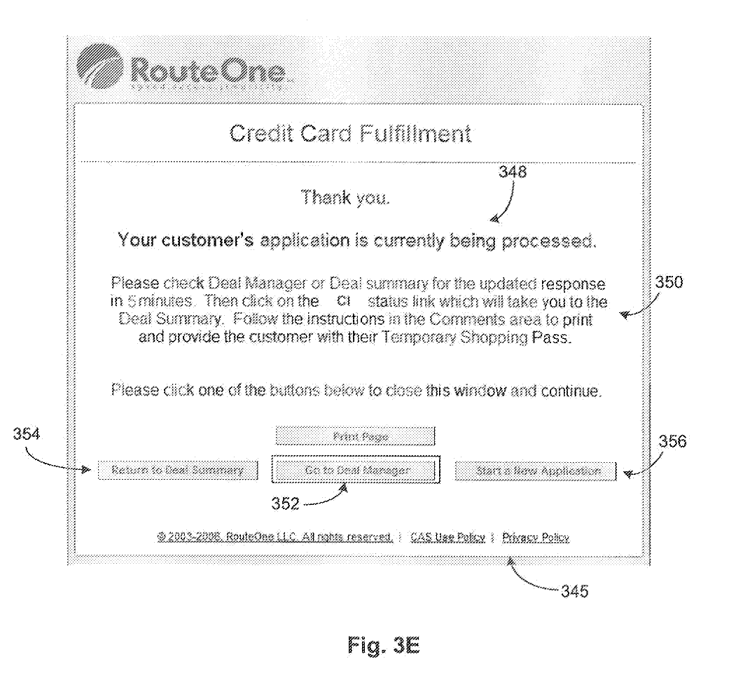

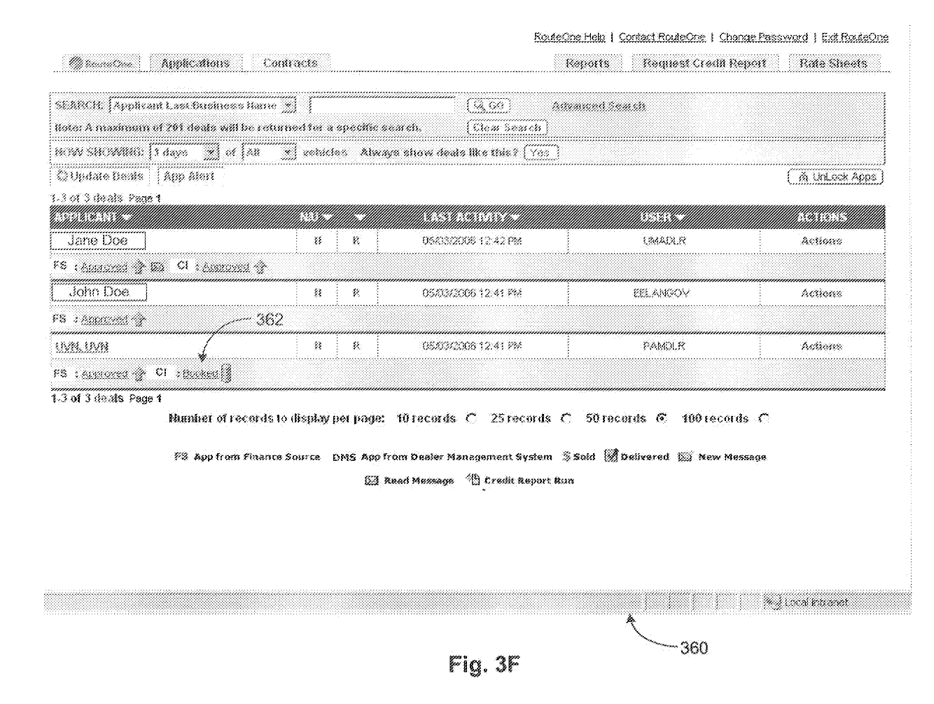

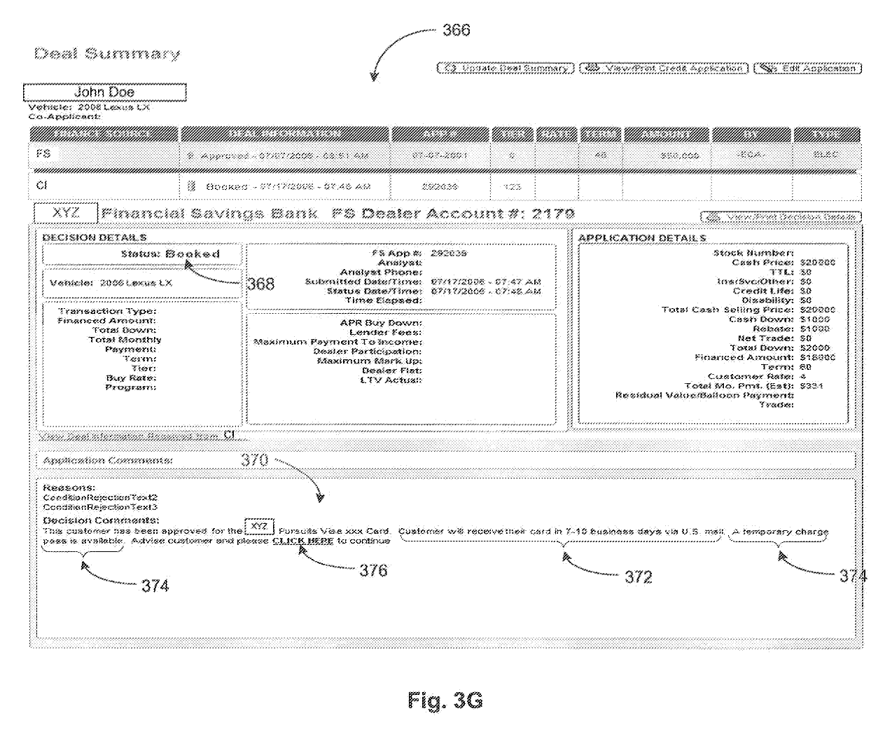

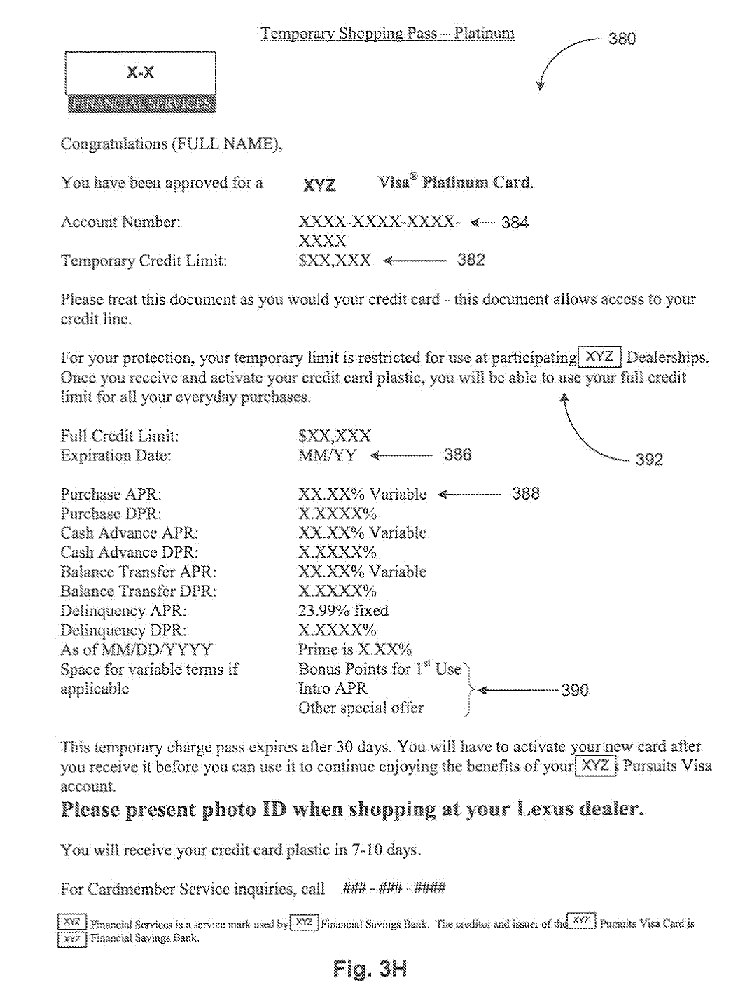

FIGS. 2A-2D are operational flow diagrams for acquiring a credit card or credit line on behalf of customers of vehicle dealerships according to an embodiment of the invention. The operational steps associated with FIGS. 2A-2D will be described with the aid of system 100 (FIG. 1) and a set of exemplary webpage screen shots (FIG. 3A-3H) displayed on, for example, an internet browser during the acquisition of instant credit for a customer.

Referring to FIG. 2A, at step 202, a dealer or sales/service employee at a vehicle dealership 102a sends a customer credit application, in electronic format (e.g., using STAR XML), from an internet browser running on computer 103a to the credit aggregation management (CAMS) system 110 running on server 108. At step 204, once the credit application is received, the credit aggregation management (CAMS) system 110 determines whether a joint marketing agreement (JMA) is in place between the dealership 102a and the financial source to which the credit application is to be sent. If a JMA does not exist (206), the credit application process is aborted (step 208). If a JMA does exist (step 206), the credit application received from dealership 102a is routed by the credit aggregation management (CAMS) system 110 to the corresponding computer servers of one or more financial sources such as servers 104a and 104b based on information stored in database 114. Database 114 includes, in addition to other data, a list of financial sources (e.g., Capital One, Lexus Financial Bank, etc.) that are authorized to receive credit application's from each dealership utilizing the credit aggregation management system 110 (step 210). At step 210, pre-screen data derived from the credit application by the credit acquisition application program 112 is routed by the credit aggregation management system 110 in the form of credit application fields to a corresponding computer server of one or more credit card institutions such as computer server 106a. Once received, the pre-screen data is used by the credit card institution for pre-approving the customer for a credit card that may be utilized by the customer instantly upon final approval. The routed pre-screen data may include a customer name, a customer address, and a national identifier (e.g., Social Security Number (SSN), Social Insurance Number (SIN), National Insurance Number (NIN), etc.) associated with the potential customer at the dealership.

Although credit card institution servers 106a and 106b are depicted as being separate entities, these servers may be incorporated within the financial source computer servers 104a, 104b. For example, if a financial source (e.g., Lexus Financial Services®) includes an affiliated financial source (e.g., Lexus Financial Savings Bank®) capable of establishing a credit card version (e.g., Lexus Pursuits Card®) of the financial source, the financial source server 104a (e.g., Lexus Financial Services®) and the credit card institution server 106a (e.g., Lexus Financial Savings Bank®) may be integrated as either a single computer server architecture, remotely located multiple computer servers communicatively coupled over one or more communication networks (e.g., WANs), and/or multiple local computer servers communicatively coupled over one or more local communication networks (e.g., LANs).

Referring to FIG. 2B, at step 212, a credit card pre-approval decision is sent from credit card institution server 106a to the CAMS system 110. The credit acquisition application program 112 of the CAMS 110 system generates a webpage that may be downloaded to computer 103a of dealership 102a in order to facilitate the viewing of all status information corresponding to credit applications (e.g., vehicle-financing, credit card application, etc.) applied for on behalf of the dealership customers by the dealership employees (e.g., sales/service person). An example of such a downloaded webpage 300 is illustrated in FIG. 3A. As illustrated in exemplary webpage 300, a deal manager screen indicates that customer John Doe 302 has been “Approved” for both an automobile loan application front the financial source, as indicated by 304, and a credit card from an affiliated or corresponding credit card institution, as indicated by 306. As shown on the webpage 300, the “Approved” status is in hyperlink form, which allows the dealership employee to further obtain more detailed information on any pre-approved loans by clicking on the hyperlink.

At step 214 (FIG. 2B), the dealership employee also has an opportunity to view summary information associated with the credit applications (e.g., vehicle-financing, credit card application, etc.) applied for on behalf of a customer. Accordingly, the credit acquisition application program 112 of the CAMS 110 system generates a webpage that may be downloaded to computer 103a of dealership 102a in order to facilitate a viewing of summary information corresponding to the customer's credit applications (e.g., vehicle-financing, credit card application, etc.). An example of such a downloaded webpage 310 is illustrated in FIG. 3B. As illustrated in exemplary webpage 310, a summary of customer John Doe's 312 credit applications, as indicated at 314 and 316, is provided. At 314, John Doe's auto loan application to the financial source (FS) is shown, whereby the term of the loan (i.e., 48 months), amount of the loan (i.e., $50,000) and initiator of the loan (i.e., dealership employee identifier ECE) is displayed. Also, the pre-approved status of the auto loan (i.e. “Approval”) and details of the loan application are indicated at 318 and 320, respectively. Similarly, at 316, John Doe's credit card application to the credit card institution (CI) is shown, whereby the identity of the credit card institution and the pre-approved status of the auto loan (i.e., “Approval”) are identified at 322 and 324, respectively. A comments section associated with the pre-approved status of the credit card application is indicated at 326 of webpage 310, whereby the customer may be informed that they have been pre-qualified for an “XYZ Pursuits Visa xxx Card.” The comments section may also include hyperlink 328, which provides the customer with an opportunity to further proceed with acquiring the credit card following the initial pre-approval process.

At step 216 (FIG. 2B), if it is determined that hyperlink 328 (FIG. 3B) has been activated, the credit acquisition application program 112 of the CAMS 110 system generates a webpage that may be downloaded to computer 103a of dealership 102a. The generated webpage provides the customer with an opportunity to “accept” or “decline” the pre-approved credit card offer. An example of such a downloaded webpage 330 is illustrated in FIG. 3C. Downloaded webpage 330 includes buttons such as an “Accept Offer” button 332, a “Decline Offer” button 334, fillable customer and dealer information fields 336, a “Print Terms & Conditions” button 338, and a confirmation “Yes” box 340. Alternatively, if hyperlink 328 is not activated (step 216), the process for obtaining the pre-approved credit card offer is terminated (step 218). By activating “Print Terms & Conditions” button 338, the terms and conditions of the credit card (e.g., APR, grace period, etc.) are displayed to the customer. Once the terms are displayed, the customer may confirm viewing these terms by marking the “Yes” box 340. As illustrated in FIG. 3C, the “Accept Offer” button 332, “Decline Offer” button 334, and fillable customer and dealer information fields 336 remain grayed out, which indicates that they are inactive. By specifying that the terms and conditions of the credit card have been read by marking or checking the “Yes” box 340, the “Accept Offer” button 332, “Decline Offer” button 334, and fillable customer and dealer information fields 336 become active, as indicated by webpage 330 illustrated in FIG. 3D.

Referring to FIGS. 2C and 3D, if it is determined that the customer has viewed the terms and conditions by marking or checking the “Yes” box 340 (step 222), the “Accept Offer” button 332 and “Decline Offer” button 334 is activated (step 226), and the fillable customer and dealer information fields 336 may be populated (step 228). At step 230, it is determined whether the fillable customer and dealer information fields 336 have been populated. Once fields 336 have been filled, it is determined whether the customer has opted to accept or decline the offer by activating either the “Accept Offer” button 332 or the “Decline Offer” button 334 (step 232).

At step 234, if the “Accept Offer” button 332 is activated, thereby signifying acceptance of the credit card offer, the credit acquisition application program 112 of the CAMS 110 system may generate webpage 345 (FIG. 3E), where the generated webpage 345 informs the customer that their credit application is being processed, as indicated at 348 (FIG. 3E). Webpage 345 also provides instructions for facilitating viewing the status of the accepted offer that is being processed, as indicated at 350 (FIG. 3E). For example, by activating a “Go to Deal Manager” button 352 (FIG. 3E), as illustrated in FIG. 3F, a deal manager webpage 360 is generated and downloaded to the browser of computer 103a (FIG. 1). Alternatively, for example, if the “Return to Deal Summary” button 354 (FIG. 3E) is activated, as illustrated in FIG. 3G, a deal summary webpage 366 (FIG. 3G) is generated and downloaded to the browser of computer 103a. Also, an opportunity for starting a new credit application (e.g., credit card, vehicle loan, etc.) on behalf of the dealership customer may be realized by activating the “Start a New Application” button 356.

Referring to FIG. 2D, if the deal manager webpage 360 (FIG. 3F) is activated (step 240), a hyperlink 362 to status information associated with accepted credit card offer is provided (step 242). The deal manager page may generally provide information, including status, for all credit applications that are processed by the CAMS system 110. If hyperlink 362 is activated (step 244), at step 246 a deal summary webpage 366 (FIG. 3G) corresponding to a particular credit card institution's (CI) credit card is accordingly generated and downloaded to the browser of computer 103a (FIG. 1). Deal summary webpage 366 (FIG. 3G) may provide, among other features, status information 368 for the accepted credit card offer and a comment section 370 associated with the approval of the accepted credit card offer. For example, the status information 368 may show a booked status, which indicates that the credit card institution has received and approved the accepted credit card offer by the customer. In the comments section 370, information such as the time period over which the customer may receive the actual credit card (e.g., 7-10 days) is illustrated, as indicated at 372. Other information such as the availability of a temporary shopping pass based on the approved credit card is also provided, as indicated at 374. A means for generating such a temporary pass may also be provided in the form of a hyperlink 376.

If hyperlink 376 is activated (step 250), at step 252 a printable temporary shopping pass webpage 380 (FIG. 3H) is generated and downloaded to the browser of computer 103a (FIG. 1). The downloaded temporary shopping pass webpage 380 may be printed out for the customer and used immediately for the purchase of goods and/or services at the vehicle dealership 102a. As illustrated in FIG. 3H, various information regarding the credit card and its terms of use may be provided. For example, a temporary credit limit 382, account number 384, expiration date 386, purchase APR 388, and bonus/special offer terms 390 may be indicated on the shopping pass 380 for the customer's benefit. The printable temporary pass webpage 390 may also include information associated with the terms of its use. For example, the shopping pass may indicate that for security reasons, use of the temporary pass may be restricted to the vehicle dealership 102a (FIG. 1) until the customer receives (e.g., via mail) and activates their actual credit card, as indicated at 392. The shopping pass details presented in FIG. 3H are however exemplary, and may change in accordance with various existing business arrangement between the vehicle dealership, the financial source, and any affiliated credit card institution.

If, however, at step 240 the “Return to Deal Summary” button 354 (FIG. 3E) is activated, as illustrated in FIG. 3G, a deal summary webpage 366 is generated and downloaded to the browser of computer 103a. Alternatively, if webpage 345 (FIG. 3E) is displayed as a pop-up window overlaying an already downloaded deal summary webpage, upon activation of the “Return to Deal Summary” button 354, the pop-up webpage 345 is closed and the already downloaded deal summary webpage becomes the active window. As previously described, the deal summary webpage 366 includes status information 368 for the accepted credit card offer (e.g., Status: “Booked”) and a comment section 370 associated with the approval of the accepted credit card offer, whereby, for example, time period information over which the customer receives the actual credit card (e.g., 7-10 days) and information associated with acquiring a temporary shopping pass based on the approved credit card is provided, as indicated at 374. By accessing the deal summary webpage 366, a temporary shopping pass associated with a specific credit card application may be accessed and printed via hyperlink 376.

However, by accessing the deal manager webpage 360 (FIG. 3F), status information is first displayed for all credit applications that are processed by the CAMS system 110 (FIG. 1). If hyperlink 362 (FIG. 3F) of the deal manager webpage 360 (FIG. 3F) is then activated, the deal summary webpage 366 (FIG. 3G) and temporary shopping pass may be accessed. Consequently, the deal summary webpage 366 (FIG. 3F) provides a more direct route to printing temporary shopping pass 380 (FIG. 3H) in comparison to the deal manager webpage 360 (FIG. 3F).

Referring back to FIG. 2C, if the “Decline Offer” button 334 of webpage 330 (FIG. 3D) is activated, thereby indicating rejection of the credit card offer, the credit acquisition application program 112 of the CAMS 110 system sends a response message to the corresponding credit card institution computer server informing the credit card institution that the customer does not wish to, at this time, proceed with acquiring the offered credit card.

At various stages of the pre-approval, offer acceptance, and approval of the credit card to the customer, a fee payment structure may be in place in order to deposit or initiate payment to the credit management (CMS) computer system 109 (FIG. 1). This payment to the CMS computer system 109 (FIG. 1) may be made in whole or partly by the vehicle dealership, financial source, and/or the credit card institution based on contractual business arrangements between these entities. Business arrangements between a financial source and credit card institution may include customized credit card terms such as providing additional bonus points for customer purchases made upon issuance of the temporary shopping pass, whereby these bonus point may be exchanged or redeemed for cash back, gifts, air miles, vehicle accessory items, vehicle servicing, and more. Other customized credit card terms may include, but are not limited to, a discounted annual percentage rate (APR), an extended introductory APR rate (i.e., lower than credit card's annual APR), and a reduced annual APR rate in comparison to average APR offerings from other credit card institutions for a given credit score or other bench mark. Other business arrangements may exist between the vehicle dealership and the dealership customer, whereby the vehicle dealership agrees to give special offer deals and/or sale prices on the purchase of certain items based on the dealership customer accepting the pre-approved credit card offer. Another business arrangement may exist between the vehicle dealership and a credit card institution affiliated to, or part of the financial source, whereby special incentives are included based on the customer accepting the pre-approved credit card. For example, multiple bonus points may be accrued by the customer for items (i.e., vehicles, accessories, service packages, upgrade packages) that are purchased at the dealership, thus providing an incentive to the customer to immediately start using their acquired credit line at the dealership.

The credit card offers associated with various vehicle dealerships may depend on the existence of several business relationships between the vehicle dealership, financial source, and/or the credit card institution. In some instances, a financial source may generate a credit card version of the financial source. In this case, the credit card institution may include a department or division, within or affiliated to, the financial source. The credit card version may also include several credit card offers ranging from, for example, standard, gold, and platinum type credit cards, whereby each card type includes different terms and conditions (e.g., APR, credit limit, etc.). In another instance, one or more credit card institutions affiliated to the financial source may generate a credit card version of the financial source. In yet another instance, credit card versions of the financial source may be generated by both departments/divisions within or affiliated to the financial source and credit card institutions affiliated to the financial source.

The term “instant credit” may generally apply to a customer's ability to acquire an offered line of credit via, for example, one or more credit approval processes, whereby upon approval of the credit, the customer may immediately purchase goods or services if desired. For example, if the line of credit includes an offered credit card, immediately upon approval of the credit card, the customer has the ability to use the credit card prior to receiving the actual credit card.

While the invention has been described and illustrated in considerable detail with reference to certain preferred embodiments herein, other embodiments are possible. Additionally, as such, the foregoing illustrative embodiments, examples, features, advantages, and attendant advantages are not meant to be limiting of the present invention, as the invention may be practiced according to various alternative embodiments, as well as without necessarily providing, for example, one or more of the features, advantages, and attendant advantages that may be provided by the foregoing illustrative embodiments.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Except to the extent necessary or inherent in the processes themselves, no particular order to steps or stages of methods or processes described in this disclosure, including the Figures, is implied. In many cases the order of process steps may be varied, and various illustrative steps may be combined, altered, or omitted, without changing the purpose, effect or import of the methods described.

Accordingly, while the invention has been described and illustrated in connection with preferred embodiments, many variations and modifications as will be evident to those skilled in this art may be made without departing from the scope of the invention, and the invention is thus not to be limited to the precise details of methodology or construction set forth above, as such variations and modification are intended to be included within the scope of the invention. Therefore, the scope of the appended claims should not be limited to the description and illustrations of the embodiments contained herein.

What is claimed is:

1. A computer-implemented method of providing for a credit card offer to a customer during a transaction for the customer to acquire an asset offered by a dealer, the computer-implemented method comprising:
acquiring, via a computer operated by the dealer, information for inclusion in a first credit application for financing the asset for acquisition by the customer;
generating, based on at least a portion of the acquired information, a second credit application for submission to a credit card institution;
electronically sending the second credit application to a credit card institution; and
displaying on the computer operated by the dealer a status indication associated with the approval of the second credit application based on an electronic communication received from the credit card institution.

2. The computer-implemented method according to claim 1, wherein generating said second credit application comprises extracting information from the first credit application.

3. The computer-implemented method according to claim 1, wherein sending the second credit application to the credit card institution is conditioned upon the existence of an existing business arrangement between the dealer and the financial source.

4. The computer-implemented method according to claim 1, further comprising displaying on the computer operated by the dealer at least one special offer to be offered by the dealer to the customer based on an approval of the second credit application.

5. The computer-implemented method according to claim 1, wherein the credit card institution is an agent of a credit card issuer.

6. The computer-implemented method according to claim 1, further comprising:
generating the first credit application;
electronically sending the first credit application at least one financial source; and
displaying on the computer operated by the dealer a status indication associated with the approval of the first credit application based on an electronic communication received from the at least one financial source.

7. The computer-implemented method according to claim 1, wherein said acquiring information comprises displaying on the computer operated by the dealer at least one input screen providing for the input of information received from the customer.

8. The computer-implemented method according to claim 1, wherein said acquiring information comprises displaying on the computer operated by the dealer at least one screen allowing the dealer to select at least a portion of the information based on stored data characterizing the asset to be acquired.

9. The computer-implemented method according to claim 1, wherein the asset is a vehicle.

10. The computer-implemented method according to claim 1, wherein the asset acquisition is a lease or a purchase.

11. A method of receiving a credit line at a vehicle dealership, the method comprising:
submitting at the vehicle dealership a first credit application to a financial source for receiving a first credit approval associated with an acquisition;
extracting information fields from the first credit application;
generating a second credit application to a credit card institution for receiving a second credit approval based on the extracted information fields, wherein the second credit application is generated based on an existing business arrangement between the vehicle dealership and the financial source;
sending the second credit application to a credit card institution for pre-approval of the second credit application; and
receiving at the vehicle dealership a status indication associated with the pre-approval of the second credit card application.

12. The method according to claim 11, wherein the status indication comprises approval or withdrawal of the second credit application.

13. The method according to claim 11, wherein the information fields comprise identification information associated with the vehicle dealership.

14. The method according to claim 11, wherein the information fields comprise name and address information associated with an applicant applying for the first credit approval.

15. The method according to claim 11, wherein the information fields comprise a national identity number associated with an applicant applying for the first credit approval.

16. The method according to claim 15, wherein the national identity number comprises a social security number (SSN) or a social insurance number (SIN).

17. The method, according to claim 11, wherein the information fields comprise user identification information associated with accessing a credit aggregation system (CAS).

18. The method according to claim 11, wherein the information fields comprise a conversation identifier associated with the first credit application submitted at the dealership.

19. The method according to claim 11, further comprising the step of:
displaying business rules to an applicant of the first credit application based on the pre-approval of the second credit application.

20. The method according to claim 19, further comprising the step of:
printing the displayed business rules for review by the applicant.

21. The method according to claim 20, further comprising the step of:
confirming the review of the printed business rules.

22. The method according to claim 21, further comprising the step of:
accepting the pre-approved second credit card application based the confirmation of the review of the business rules.

23. The method according to claim 22, further comprising the step of:
receiving instructions for monitoring approval status for the pre-approved second credit card application.

24. The method according to claim 23, wherein receiving the instructions comprises receiving decision information associated with the second credit card application.

25. The method according to claim 24, wherein the decision information comprises at least one of the group consisting of a booked status, a conditioned status, or a withdrawn status.

26. The method according to claim 25, further comprising the step of:
generating a temporary document for allowing the applicant to make additional purchases based on the decision information indicating the booked status.

27. The method according to claim 26, wherein the temporary document comprises a credit card substitute for a predefined limited period prior to the applicant receiving an actual credit card based on receiving the second credit approval.

28. A method of receiving a credit line at a vehicle dealership, the method comprising:
submitting at the vehicle dealership a first credit application to a financial source for receiving a first credit approval associated with a acquisition;
extracting information fields from the credit application;
submitting a second credit application to a credit card institution for receiving a second credit approval based on the extracted information fields, wherein at least one term associated with the second credit approval is customized according to at least one business term between the financial source and the credit card institution;
sending the second credit application to a credit card institution for pre-approval of the second credit application; and
receiving at the dealership a status indication associated with the pre-approval of the second credit card application.

29. The method according to claim 28, wherein if the status indication includes confirmation of the approval of the second credit application, then, issuing an applicant of the first and second credit application with a temporary document for allowing the applicant to make additional purchases.

30. The method according to claim 28, wherein the at least one business term comprises earning additional points for making additional purchases upon issuance of the temporary document.

31. The method according to claim 30, wherein the additional purchases include purchasing products from the vehicle dealership.

32. The method according to claim 28, wherein the at least one business term comprises a discounted annual percentage rate (APR).

33. The method according to claim 32, wherein the discounted APR comprises providing an extended introductory APR rate.

34. The method according to claim 32, wherein the discounted APR comprises providing a low APR rate in comparison to existing APR offerings from other credit card institutions.

35. A method of receiving a credit line at a vehicle dealership utilizing a credit aggregation management system, the method comprising:
submitting using the credit aggregation management system a first credit application to a financial source for receiving a first credit approval associated with an acquisition;
extracting information fields from the credit application;
submitting a second credit application to a credit card institution for receiving a second credit approval based on the extracted information field, wherein the credit card institution generates a credit card version of the financial source;
sending the second credit application to a credit card institution for pre-approval of the second credit application, wherein upon approval of the second credit application the vehicle dealership receives a fee from the credit card institution; and
receiving at the vehicle dealership a status indication associated with the pre-approval of the second credit card application.

36. The method according to claim 35, wherein a joint marketing agreement (JMA) exits between the vehicle dealership and the financial source.

37. A system for providing instant credit to a customer of a vehicle dealership via a communications network, the system comprising:
a database for mapping the vehicle dealership to at least one financial source based on the customer seeking from the financial source a first credit pre-approval for an acquisition;
a credit aggregation management system operatively coupled to the database, the credit aggregation management system providing access to the financial source on behalf of the customer seeking the first credit pre-approval, wherein the credit aggregation management system facilitates acquisition of the first credit pre-approval from the financial source by receiving credit card application information; and
a credit acquisition application program operatively coupled to the credit management system and the database, wherein the credit acquisition management system facilitates acquisition of a second credit pre-approval from a credit card institution over the communication network on behalf of the customer based on at least a portion of the received credit card information, wherein acquisition of the second credit pre-approval is contingent upon an established business relationship between the vehicle dealership and the financial source.

38. The system according to claim 37, wherein the acquisition comprises a sale agreement on a vehicle or a lease agreement on a vehicle.

39. The system according to claim 37, wherein the established business relationship comprises a joint marketing agreement.

40. The system according to claim 37, wherein the established business relationship comprises agreed terms and conditions between the vehicle dealership and the financial source.

41. The system according to claim 37, wherein the established business relationship comprises agreed terms and conditions between the financial source and an associated credit card institute.

42. A computer program product comprising a computer program embodied on at least one computer readable medium, the computer program when executed being operative in performing a method for providing a credit card offer to a customer during a transaction for the customer to acquire an asset offered by a dealer in a computer environment, the method comprising:
receiving information for inclusion in a first credit application for financing the asset purchase;
generating, based on at least a portion of the acquired information, a second credit application for submission to a credit card institution;
electronically sending the second credit application to a credit card institution; and
providing a status indication associated with the approval of the second credit application based on an electronic communication received from the credit card institution.
